(19) United States
(12) Patent Application Publication
(10) Pub. No.: US 2025/0209579 A1
(43) Pub. Date: Jun. 26, 2025

(54) IMAGE PROCESSING APPARATUS, IMAGE CAPTURING APPARATUS, CONTROL METHOD, AND STORAGE MEDIUM

(71) Applicant: CANON KABUSHIKI KAISHA, Tokyo (JP)

(72) Inventor: Kashu MATSUMOTO, Kanagawa (JP)

(21) Appl. No.: 18/981,739

(22) Filed: Dec. 16, 2024

(30) Foreign Application Priority Data
Dec. 20, 2023 (JP) 2023-215049

(51) Int. Cl. G06T 5/70; H04N 23/63

(52) U.S. Cl. CPC G06T 5/70; H04N 23/63; G06T 2207/20021; G06T 2207/20092

(57) ABSTRACT

An image processing apparatus, comprising: a selecting unit configured to select a localized area from a first image displayed in live view on a display unit; a processing unit configured to generate a second image indicating the localized area from the first image and perform image quality enhancement processing on the second image; and a control unit configured to display a third image obtained via the image quality enhancement processing by the processing unit on the display unit.

### BACKGROUND OF THE INVENTION

### Field of the Invention

The present invention relates to an image processing apparatus, an image capturing apparatus, a control method, and a storage medium.

### Description of the Related Art

Recently, in cameras and similar image capturing apparatuses, DeBayer processing (demosaic processing) is performed on raw image information (RAW image) captured by an image capturing sensor to convert the image information into signals including brightness and color difference. Also, image quality enhancement processing, optical distortion correction, image correction, and similar so-called development processing is performed on each signal.

In a case where image capture is performed in an environment including many low-brightness areas, the image capturing sensor sensitivity of the image capturing apparatus may be set to high for image capture. However, when image capture is performed with such a high sensitivity setting, noise tends to be produced in the image. Thus, there is a demand for image quality enhancement, in particular, an enhancement in noise reduction processing performance.

A known technology for generating an image with reduced noise and enhanced image quality includes an image quality enhancement processing method using noise reduction (hereinafter, referred to as NR). However, to perform highly accurate NR processing, a large amount of arithmetic and logic operations are necessary, meaning that processing takes time.

In regards to this, Japanese Patent Laid-Open No. 2014-179851 describes reducing the processing time by having different image processing method before and after image capture. Specifically, at the time of the image capture operation, image processing and confirmation of the image needs to be performed quickly. Thus, image quality enhancement processing emphasizing speed is performed by performing simple image processing. Then, in the method for after image capture when an image is displayed and confirmed, image quality enhancement using higher-load image processing is emphasized. Accordingly, during an image capture operation, how much can the noise in the image captured by the image capturing apparatus be reduced can be confirmed.

However, with the technology described in Japanese Patent Laid-Open No. 2014-179851, since the image quality enhancement processing is different before and after image capture, it is difficult to confirm whether or not the desired image can be captured at the time of the image capture operation. In other words, it is hard for the user to confirm the noise reduction effect at an early stage.

### SUMMARY OF THE INVENTION

The present invention has been made in consideration of the aforementioned problems and enables realization of technology for a user to confirm a noise reduction effect at an early stage.

According to one aspect of the present invention, there is provided an image processing apparatus, comprising: a selecting unit configured to select a localized area from a first image displayed in live view on a display unit; a processing unit configured to generate a second image indicating the localized area from the first image and perform image quality enhancement processing on the second image; and a control unit configured to display a third image obtained via the image quality enhancement processing by the processing unit on the display unit.

Further features of the present invention will become apparent from the following description of exemplary embodiments (with reference to the attached drawings).

### BRIEF DESCRIPTION OF THE DRAWINGS

FIG. 1 is a diagram of the hardware configuration of a camera that can be used to implement each embodiment.

FIG. 2 is a diagram of the functional configuration of the camera that can be used to implement each embodiment.

FIG. 3 is a flowchart illustrating the process of processing according to an embodiment.

FIG. 4A is a flowchart illustrating the process of processing to switch to image quality enhancement processing at the time of image capture at a high sensitivity setting according to an embodiment.

FIG. 4B is a flowchart illustrating the process of processing to switch to image quality enhancement processing using average brightness of an image to be captured according to an embodiment.

FIG. 4C is a flowchart illustrating the process of processing to switch to image quality enhancement processing based on a low-brightness area ratio of an image to be captured according to an embodiment.

FIG. 5A is a diagram illustrating an example of a notification via pop-up display.

FIG. 5B is a diagram illustrating an example of a notification via output of a message in a localized area image.

FIG. 5C is a diagram illustrating an example of a notification via a colored outer frame of a localized area image.

FIG. 6A is a diagram illustrating an example of designating an area of a localized area for performing image quality enhancement processing.

FIG. 6B is a diagram illustrating an example of designating processing content for image quality enhancement processing.

FIG. 7 is a diagram illustrating an example of displaying an image quality enhancement processing effect on a screen according to a first embodiment.

FIG. 8A is a diagram illustrating an example of displaying an image quality enhancement processing effect on a screen according to a second embodiment (equal magnification of a localized area image subjected to image quality enhancement processing).

FIG. 8B is a diagram illustrating another example of displaying an image quality enhancement processing effect on a screen according to a second embodiment (display of a comparison of a localized area image before and after image quality enhancement processing).

FIG. 9 is an example of an output device for confirming an image quality enhancement processing effect according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

An embodiment of the present invention applied to a camera will be described below. However, the present invention can be applied to any electronic device that can perform image quality enhancement processing during moving image capture. Such electronic devices include but are not limited to image capturing apparatuses such as digital cameras and digital video cameras, as well as personal computer, mobile phones, drive recorders, robots, drones, and similar devices with a camera function.

### Hardware Configuration

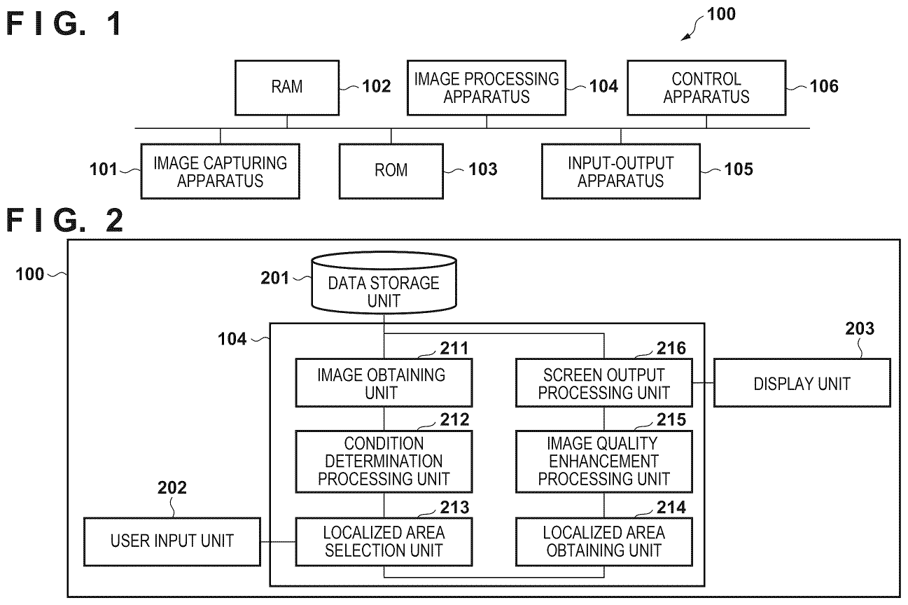

FIG. 1 illustrates an example of the hardware configuration of a camera according to the present embodiment. A camera 100 according to the present embodiment includes an image capturing apparatus 101, a RAM 102, a ROM 103, an image processing apparatus 104, an input-output apparatus 105, and a control apparatus 106. Note that each apparatus is connected to one another via a bus and configured to communicate with one another. Also, in the present embodiment, the camera 100 is illustrated as including the image capturing apparatus 101, but the entire camera 100 may be referred to as an image capturing apparatus.

The image capturing apparatus 101 is constituted of an image capturing lens, an image sensor, an A/D converter, a diaphragm control apparatus, a focus control apparatus, and the like. The image capturing lens includes a fixed lens, a zoom lens, a focus lens, a diaphragm, and a diaphragm motor. The image sensor includes a CCD, CMOS, or the like for converting an optical image of the subject into an electrical signal.

The A/D converter converts analog signals into digital signals. The image capturing apparatus 101 converts the subject image formed on an image forming surface of the image sensor by the image capturing lens into an electrical signal, applies A/D conversion processing to the electrical signal via the A/D converter, and supplies this as image data to the RAM 102. By successively transferring and displaying the image data on the input-output apparatus 105, live view display can be performed. The input-output apparatus 105 may be a rear monitor provided in the camera 100. Live view can be displayed in a still image capture standby state, a moving image capture standby state, a moving image recording state, and the like. With live view, the captured subject image is displayed in approximately real time.

The diaphragm control apparatus controls the operation of the diaphragm motor and controls the diaphragm of the image capturing lens by changing the aperture diameter of the diaphragm. The focus control apparatus controls the operation of the focus motor on the basis of the phase detection of a pair of signals for focus detection obtained from the image sensor and controls the focal state of the image capturing lens by driving the focus lens.

The RAM 102 stores image data obtained by the image capturing apparatus 101 and image data for display on the input-output apparatus 105. The RAM 102 includes a sufficient storage capacity to store a predetermined number of still images and moving images of a predetermined amount of time. Also, the RAM 102 also functions as the memory for image display (video memory) and supplies image data for display to the input-output apparatus 105.

The ROM 103 is a storage device such as a magnetic storage apparatus, a semiconductor memory, or the like and stores various types of programs, data that needs to be stored for a long time, and the like. The image processing apparatus 104 performs image quality enhancement processing on the image with noise to reduce noise and enhance the image quality. The configuration and operations of the image processing apparatus 104 will be described below in detail. The input-output apparatus 105 is constituted of an input device group including a switch, button, key, touch panel, and/or the like for the user to input an instruction to the camera 100 and a display device such as an LCD, an organic EL display, or the like. Input via the input device group is detected by the control apparatus 106 via the bus, and the control apparatus 106 controls each unit for implementing the operation corresponding to the input. Also, in the input-output apparatus 105, the touch detection screen of the touch panel corresponds to the display surface of the display device. The touch panel may be a touch panel of various types including a resistive film type, a capacitance type, an optical sensor type, or the like. The input-output apparatus 105 displays the live view image by successively transferring and displaying the image data.

The control apparatus 106 includes one or more central processing units (CPUs). The control apparatus 106 implements each function of the camera 100 by executing programs stored in the ROM 103. Also, the control apparatus 106 controls the image capturing apparatus 101 and performs diaphragm control, focus control, exposure control, and the like. For example, automatic exposure (AE) processing is performed to automatically determine the exposure conditions (shutter speed, accumulated time, f-number, sensitivity) on the basis of the information of the subject brightness of the image data obtained by the image capturing apparatus 101.

Also, the control apparatus 106 can use the noise reduction processing result at a time of a high-sensitivity setting from the image processing apparatus 104 to reduce the produced noise in the image capture set to high ISO sensitivity. Also, by using the subject area detection result, the focus detection area can be automatically set, and tracking AF processing function for any subject area can be implemented. Further, AE processing on the basis of the focus detection area brightness information can be performed, and image processing (for example, gamma correction processing, auto white balance (AWB) adjustment processing, and the like) on the basis of the pixel values of the focus detection area can be performed.

The control apparatus 106 performs display control by controlling the input-output apparatus 105. For example, on the basis of the result of detection by the image processing apparatus 104, an indicator (for example, a rectangular frame including the area) representing the position of the current subject area may be superimposed on the displayed image.

The image processing apparatus 104 described in the present embodiment performs image quality enhancement processing to reduce noise in real time on the noise produced in the image displayed in live view when capturing an image of the subject in a low-brightness area with the image capturing apparatus 101 with a high ISO sensitivity setting. Then, by displaying the image quality enhancement processing effect on a display such as the rear monitor of the camera 100 in a easy-to-understand manner, the image quality enhancement processing effect is presented to the user.

In the present embodiment, the image quality enhancement processing result is confirmed in real time. Thus, only a localized area that is a portion of the image displayed in live view is subjected to the image quality enhancement processing. Also, to make the image quality enhancement processing effect more noticeable even on a display with a low resolution such as the rear monitor of the camera 100 or the like, the localized area in the image displayed in live view after image quality enhancement processing is magnified to equal magnification or near equal magnification and displayed on the screen.

### Functional Configuration

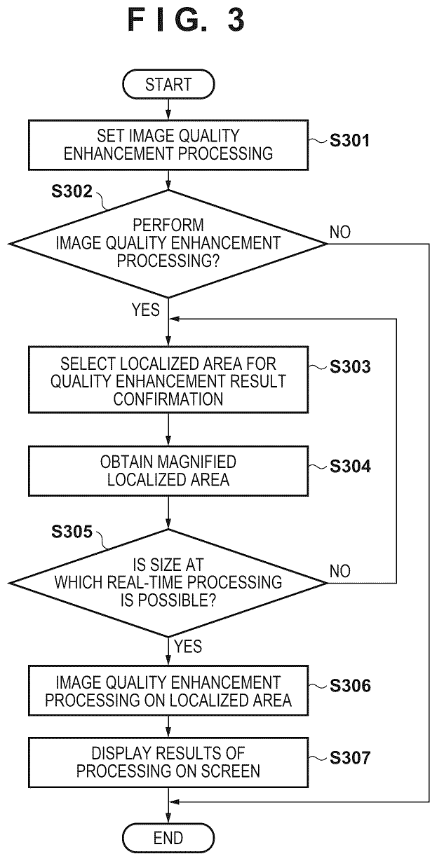

FIG. 2 is an explanatory diagram of the configuration of the camera 100 and the image processing apparatus 104 according to the present embodiment. The camera 100 includes a data storage unit 201, a user input unit 202, a display unit 203, and the image processing apparatus 104. The image processing apparatus 104 includes an image obtaining unit 211, a condition determination processing unit 212, a localized area selection unit 213, a localized area obtaining unit 214, an image quality enhancement processing unit 215, and a screen output processing unit 216.

The data storage unit 201 is an area when the images captured by the image capturing apparatus 101 are stored. Images for live view display are also temporarily stored in the data storage unit 201. The image obtaining unit 211 obtains images stored in the data storage unit 201. An obtained image is expected to be a “noisy” image captured with a high sensitivity setting for ISO 51200 for live view display, for example.

The condition determination processing unit 212 determines whether or not to perform image quality enhancement processing on the image obtained by the image obtaining unit 211. The user input unit 202 is an input device of the camera 100 and obtains information of the operations of the user on the image obtained by the image obtaining unit 211 using a touch panel liquid crystal display, for example. The input device may be an external device and may obtain the user operation information using a mouse and/or keyboard.

The localized area selection unit 213 selects a localized area in the image obtained by the image obtaining unit 211 on the basis of user operation information obtained by the user input unit 202. The localized area obtaining unit 214 obtains the localized area selected by the localized area selection unit 213 from the image obtained by the image obtaining unit 211. The image quality enhancement processing unit 215 performs image quality enhancement processing to reduce noise on the localized area image obtained by the localized area obtaining unit 214.

The screen output processing unit 216 performs processing to output the localized area image subjected to image quality enhancement processing by the image quality enhancement processing unit 215. For example, on the image displayed in live view obtained by the image obtaining unit 211, image processing is performed so that the localized area image processed by the image quality enhancement processing unit 215 is at equal magnification or near equal magnification with the resolution at a level that indicates that image quality enhancement processing has been performed, and then the localized area image is superimposed on or combined with the image displayed in live view obtained by the image obtaining unit 211.

The display unit 203 displays the result of the processing by the screen output processing unit 216 on an output device of the camera 100. As the output device, for example, a liquid crystal display or an organic EL display may be used.

### Processing

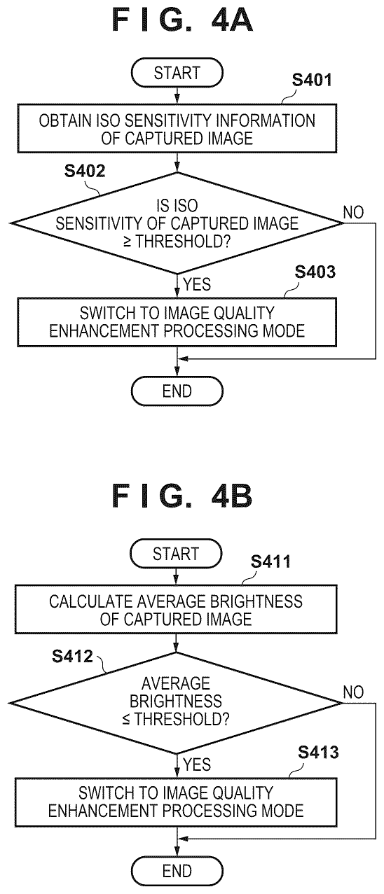

FIG. 3 is a flowchart illustrating the flow of processing according to the present embodiment. In step S301, the user input unit 202 receives from the user a switch to a dedicated mode setting for performing image quality enhancement processing. In a case where the selection of a predetermined mode (dedicated mode for performing image quality enhancement processing) from a plurality of modes is received from the user or a predetermined mode (dedicated mode for performing image quality enhancement processing) is selected, it is determined to perform image quality enhancement processing. Alternatively, by adding a setting parameter for automatically performing image quality enhancement processing to an image capturing parameter that can be set with the image capturing apparatus 101, the user can discretionarily set image quality enhancement processing to be performed on images displayed in live view thereafter.

Also, when image capture is performed in an environment that tends to produce noise, the dedicated mode setting for performing image quality enhancement processing may be automatically switched to. An environment that tends to produce noise includes cases where low-brightness areas are expected to be captured and cases where the ISO sensitivity is expected to be raised for image capture. In such environments, on the basis of a user-set threshold, the mode may switch to the dedicated mode for performing image quality enhancement processing. The switch to the dedicated mode for performing image quality enhancement processing may be automatic or a method in which the user is asked whether to switch via a pop-up message or the like that allows the user to select switch.

In step S302, the condition determination processing unit 212 determines whether or not to perform image quality enhancement processing on the basis of the dedicated mode setting for performing high-sensitivity processing performed in step S301. In a case where the mode is the dedicated mode for performing image quality enhancement processing and the condition is one for performing image quality enhancement processing, the processing proceeds to step S303. On the other hand, in a case where the mode is not the dedicated mode for performing image quality enhancement processing or the condition is not one for performing image quality enhancement processing, the processing ends.

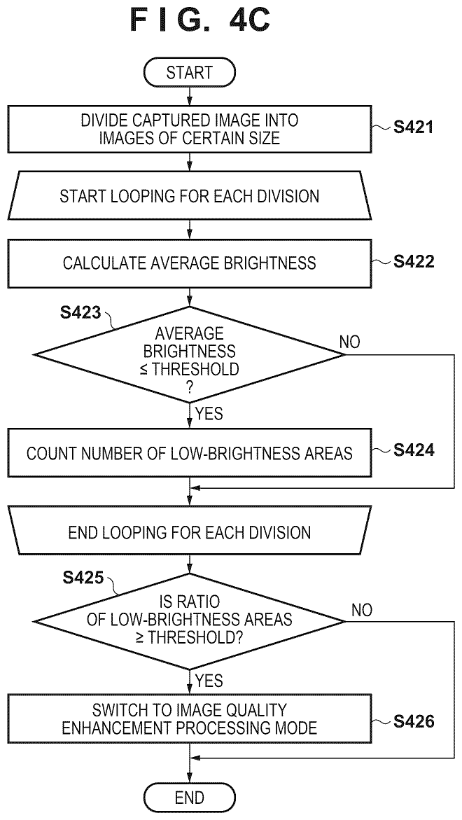

Here, FIGS. 4A, 4B, and 4C are detailed examples of processing to determine whether or not to perform the image quality enhancement processing of step S302 for the setting value set in step S301.

FIG. 4A is a detailed example of the determination processing of step S302 in a case where a threshold is set in advance by the user in regard to the ISO sensitivity in step S301. In step S401, the condition determination processing unit 212 obtains the ISO sensitivity information set in the image capturing apparatus 101. In step S402, the condition determination processing unit 212 compares the user-set threshold set in step S301 and the ISO sensitivity information obtained in step S401 and determines whether or not the ISO sensitivity is equal to or greater than the threshold. In a case where the ISO sensitivity is equal to or greater than the threshold, the processing proceeds to step S403. On the other hand, in a case where the ISO sensitivity is less than the threshold, it is determined to not perform the image quality enhancement processing and the processing ends. In step S403, the condition determination processing unit 212 switches to the dedicated mode for performing image quality enhancement processing. This ends the processing of FIG. 4A. In this manner, the ISO sensitivity information may be obtained, and if the ISO sensitivity is equal to or greater than the threshold, the image quality enhancement processing may be determined to be performed.

Next, FIGS. 4B and 4C are detailed examples of the determination processing of step S302 in a case where a threshold is set in advance by the user in regard to a low-brightness area in step S301.

In FIG. 4B, in step S411, the condition determination processing unit 212 obtains the average brightness of a first image displayed in live view obtained by the image obtaining unit 211. Note that the average brightness obtained in this step may be for the localized area image obtained by the localized area obtaining unit 214. In step S412, the condition determination processing unit 212 compares the user-set threshold set in advance in step S301 and the information of the average brightness obtained in step S411 and determines whether or not the average brightness is equal to or less than the threshold. In a case where the average brightness is equal to or less than the threshold, the processing proceeds to step S413. On the other hand, in a case where the average brightness is greater than the threshold, it is determined to not perform the image quality enhancement processing and the processing ends. In step S413, the condition determination processing unit 212 switches to the dedicated mode for performing image quality enhancement processing. This ends the processing of FIG. 4B. In this manner, the information of the average brightness of the first image may be obtained, and if the average brightness is equal to or less than the threshold, image quality enhancement processing may be determined to be performed.

Next, in FIG. 4C, in step S421, the condition determination processing unit 212 divides the first image displayed in live view obtained by the image obtaining unit 211 into images of a certain size. The processing from step S422 to step S424 is performed on all of the divided images. In step S422, the condition determination processing unit 212 calculates the average brightness for each divided image. In step S423, the condition determination processing unit 212 determines whether or not the average brightness calculated in step S422 is equal to or less than the user-set threshold set in advance in step S301. In a case where the average brightness is equal to or less than the user-set threshold, the processing proceeds to step S424. On the other hand, in a case where the average brightness is greater than the user-set threshold, the processing returns to step S422. In a case where the processing is performed on all of the divided images, the loop ends.

In step S424, the condition determination processing unit 212 counts the number of low-brightness areas. When processing on all of the divided images is complete, the loop ends, and the processing proceeds to step S425. In step S425, the condition determination processing unit 212 compares the number of low-brightness areas counted in step S424 and the user-set threshold set in step S301 and determines whether or not a ratio of the counted number of low-brightness areas to the divided number is equal to or greater than the threshold. In a case where the low-brightness area ratio is equal to or greater than the threshold, the processing proceeds to step S426. On the other hand, in a case where the low-brightness area ratio is less than the threshold, it is determined to not perform the image quality enhancement processing and the processing ends. In step S426, the condition determination processing unit 212 switches to the dedicated mode for performing image quality enhancement processing. This ends the processing of FIG. 4C. In this manner, the first image is divided into a plurality of areas, and information of the average brightness of an area for each of the plurality of areas is obtained. Then, if the ratio of areas with an average brightness equal to or less than the threshold is equal to or greater than the threshold, image quality enhancement processing may be determined to be performed.

Next, we will return to the description of FIG. 3. In step S303, the localized area selection unit 213 selects a localized area in the first image displayed in live view obtained by the image obtaining unit 211 on the basis of user operation information obtained by the user input unit 202. The user input unit 202 functions as a reception unit that receives user operations, and the user selects the localized area they wish to confirm the image quality enhancement result of from the image displayed in live view. The localized area selected from the first image is selected on the basis of the user operation information obtained by the user input unit 202.

Here, it is assumed that an operation is performed of the user pinching out and displaying at equal magnification a discretionary area in the first image obtained by the image obtaining unit 211, and the area displayed at equal magnification is selected as the localized area. However, the selection method via user operation is not limited thereto. For example, in a case where the user has touched a discretionary position they want focused in the first image obtained by the image obtaining unit 211, the touched focus position and surrounding area may be selected as the localized area. For example, a rectangular area of a predetermined size centered at the touched position (focus position) may be set as the localized area.

Also, in a case where the user has touched an object candidate area in the first image detected by the image capturing apparatus 101, the object candidate area or the surrounding area of a predetermined size containing the object candidate area may be selected as the localized area. Here, object candidate refers to an object of various categories such as person, animal, and vehicle and a localized portion such as the whole body, the head portion, or the pupil of a person or animal.

In step S304, the localized area obtaining unit 214 displays at equal magnification the discretionary area in the first image displayed in live view in accordance with the user operation. Then, in order to perform image quality enhancement processing on the localized area displayed at equal magnification, a second image (localized area image) is extracted from the image displayed in live view.

In step S305, the condition determination processing unit 212 determines whether or not the image quality enhancement processing can be performed in real time on the second image obtained in step S304. The determination of whether or not the size can be processed in real time may be performed by storing the number of pixels that can be subjected to image quality enhancement processing within 10 ms and determining whether or not the number of pixels of the localized area image obtained in step S304 is within the range of the number of pixels, for example.

Here, in a case where the number of pixels of the second image obtained in step S304 is a number of pixels that cannot be subjected to image quality enhancement processing within 10 ms, automatic adjustment is made to re-obtain the second image with a number of pixels that can be subjected to image quality enhancement processing within 10 ms. In other words, the number of pixels of the second image is adjusted so that the image quality enhancement processing can be performed in real time on the second image indicating the localized area.

Alternatively, the user may be notified that the number of pixels of the second image cannot be subjected to image quality enhancement processing in real time, and the processing from step S303 to step S305 may be repeated.

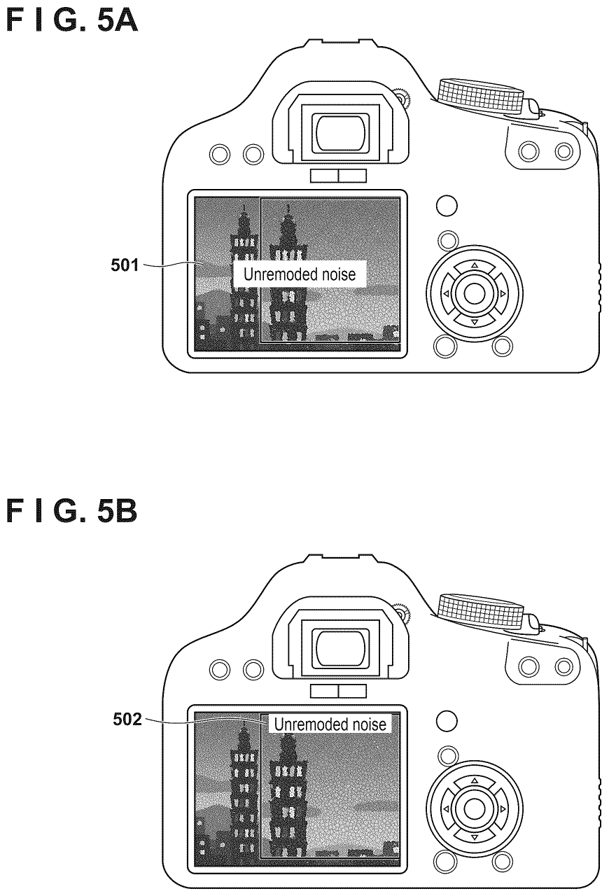

FIGS. 5A, 5B, and 5C are examples of methods of notifying the user that the number of pixels of the second image cannot be subjected to image quality enhancement processing in real time. FIG. 5A is an example in which a pop-up display 501 of a message (“Unremoved noise”) indicating that image quality enhancement processing cannot be performed in real time is displayed on the display unit 203. FIG. 5B is an example in which a message (“Unremoved noise”) 502 indicating that image quality enhancement processing cannot be performed in real time is superimposed in the second image obtained in step S304 and displayed on the display unit 203.

FIG. 5C is an example in which a display is performed using different colors for the color of an outer frame 503 of the second image obtained in step S304 in a case of image quality enhancement processing being unable to be performed in real time and a case of image quality enhancement processing being able to be performed are displayed using different colors. For example, in a case where image quality enhancement processing cannot be performed in real time, the outer frame 503 may be displayed in a red color, and in a case where image quality enhancement processing can be performed, the outer frame 503 may be displayed in a green color. The method is not limited to these methods, and the display may be divided using any display format that allows whether or not image quality enhancement processing can be performed in real time to be determined. In this manner, information indicating whether or not image quality enhancement processing can be performed in real time for the second image indicating the localized area is presented to the user, allowing them to easily recognize this.

In step S306, the image quality enhancement processing unit 215 performs the image quality enhancement processing on the second image obtained in step S304. The localized image obtained by performing the image quality enhancement processing on the second image corresponds to a third image. The image quality enhancement processing may be noise reduction processing (NR processing) with the goal of noise reduction. In a case where NR processing with higher accuracy is performed, the arithmetic and logic operation load is increased, narrowing the area of a localized area that can be subjected to processing in real time. As a solution, simple NR processing with a lighter arithmetic and logic operation load may be switched to so that the image quality enhancement processing can be performed on a localized area image with a higher number of pixels in real time. In other words, a second noise reduction processing can be performed with a smaller processing load than the normal noise reduction processing, and the second noise reduction processing may be performed on the second image indicating a localized area with a higher number of pixels than the second image and a wider area.

For example, a parameter for switching to a setting whereby NR processing can be performed on the second image with a higher number of pixels may be provided in the menu of the image capturing apparatus 101, and the arithmetic and logic operation load of the NR processing can be discretionarily adjusted by the user. Also, the image quality enhancement processing is not limited to NR processing, and a neural network model (hereinafter referred to as an NN model) trained for the purpose of noise reduction may be used. In other words, image quality enhancement processing using a neural network model trained to reduce noise may be performed.

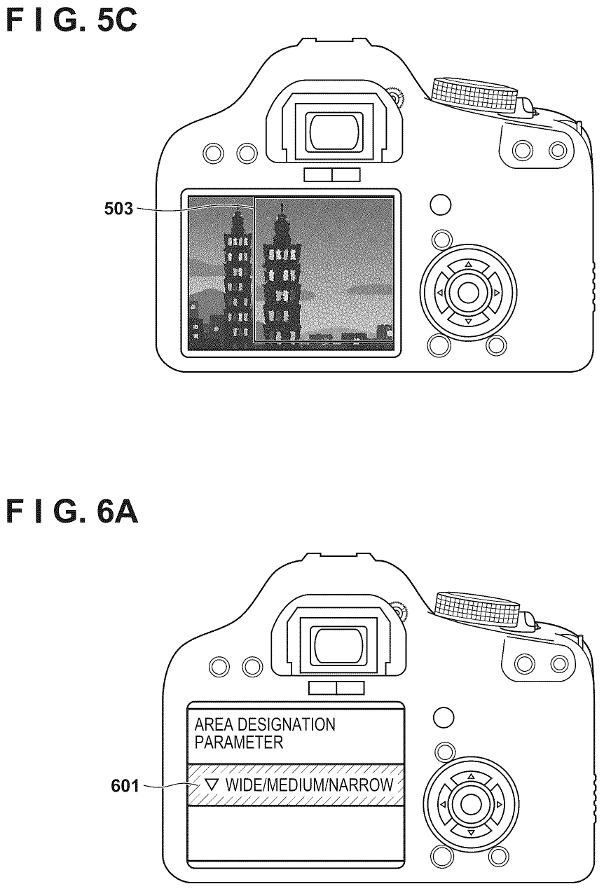

Here, FIGS. 6A and 6B are examples of a parameter menu for varying the number of pixels of the second image determined in step S305. FIG. 6A illustrates an example in which the user can select “wide, medium, narrow” from a pull-down menu for a parameter 601 for setting the area of the localized area for the number of pixels of the second image determined in step S305. For example, in a case where “wide” is selected by the user, NR processing can be performed on the second image with a wider area and a higher number of pixels. However, since relatively simpler NR processing must be performed when “narrow” is selected, the degree of image quality enhancement is reduced.

Also, FIG. 6B illustrates an example in which the user can select “strong, medium, weak” from a pull-down menu for a setting parameter (NR processing strength parameter) 602 for adjusting the arithmetic and logic operation load of the NR processing performed in step S306. For example, in a case where “strong” is selected by the user, image quality enhancement processing with high accuracy can be performed with a higher arithmetic and logic operation load, but the number of pixels of the second image that can be processed in real time is reduced, and the area of the localized area is narrowed. The added parameter menu is not limited to a pull-down menu, and, for example, a text field may be added for the number of pixels of the second image to be directly designated.

In step S307, the screen output processing unit 216 performs processing for screen output on the result of the image quality enhancement processing of step S306 and displays the third image together with the first image on the display unit 203. In the processing for screen output, to make the image quality enhancement processing result easy for the user to confirm, magnification processing of equal magnification or close to equal magnification is performed on the third image which was subjected to the image quality enhancement processing. Equal magnification processing is performed using processing that fills in between pixels such as linear interpolation or nearest-neighbor interpolation. The display unit 203 may be an output device, for example a liquid crystal display, attached to the back surface of the camera 100.

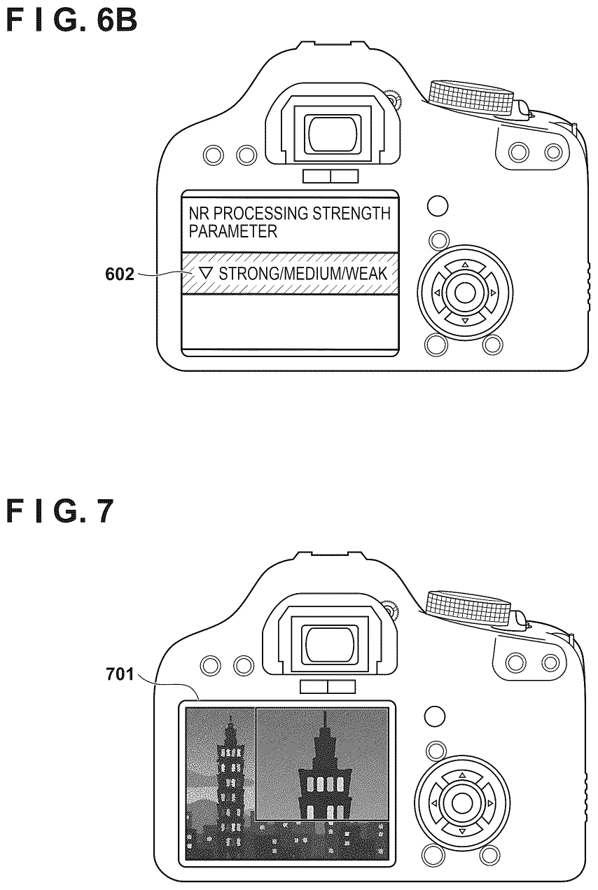

FIG. 7 illustrates an example of the image quality enhancement processing in step S306 being performed, and a result 701 obtained by superimposing or combining the post-equal-magnification third image on/with (a predetermined area of) the first image displayed in live view being displayed on the display unit 203 by the screen output processing unit 216. According to the display example of FIG. 7, even when the user adjusts the position of the camera 100 to match the motion of the subject, the user can clearly know which area in the image the image quality enhancement processing has been performed on.

The superimposed position of the third image according to the present embodiment in this example is in the upper right of the image displayed in live view as illustrated in FIG. 7, but no such limitation is intended. For example, the user may be able to discretionarily change the superimposed position, or the superimposed position may be able to be automatically adjusted so that the position selected in step S303 can be confirmed.

As described above, in the present embodiment, a localized area is selected from the first image being displayed on the display unit 203, the second image indicating the localized area is generated from the first image, and the image quality enhancement processing is performed on the second image. Then, the third image obtained via the image quality enhancement processing is displayed on the display unit 203. Specifically, on the image of the localized area selected from the image displayed in live view on the rear monitor of an image capturing apparatus such as the camera, the localized area image obtained via image quality enhancement processing is processed to a resolution of equal magnification or close to equal magnification display. Then, it is superimposed or combined on/with the image displayed in live view on the rear monitor and displayed.

According to the present embodiment, the user can confirm the noise reduction effect at an early stage, allowing them to capture the desired image. Also, the image quality enhancement processing can be performed in real time on the image displayed in live view, and the user can be presented with the result of the post-image-capture image quality enhancement processing in an easy-to-understand manner. In other words, the effect of the post-image-capture image quality enhancement processing can be confirmed in real time during an image capture operation.

Also, in the example of the present embodiment described above, NR processing relating to noise reduction processing is used. However, the present embodiment can be applied to super-resolution processing and other degradation corrections, style conversions (for example, processing to convert a color image into a monochrome image), and the like.

Note that in the example of the present embodiment described above, in a case where the mode is switched to the dedicated mode for performing image quality enhancement processing in step S301 of FIG. 3 and the condition of FIG. 4A, 4B, or 4C is satisfied, it is determined to perform the image quality enhancement processing. However, no such limitation is intended. Regardless of the condition of FIGS. 4A, 4B, and 4C, it may be determined to perform the image quality enhancement processing in response to the mode being switched to the dedicated mode for performing image quality enhancement processing in step S301 of FIG. 3. Alternatively, regardless of a switch to the dedicated mode for performing image quality enhancement processing, in a case where the condition of any one of FIGS. 4A, 4B, and 4C is satisfied, it may be determined to perform the image quality enhancement processing.

### Second Embodiment

In the present embodiment, another example will be described in which the post-image-capture image quality enhancement processing result is presented to the user in an easy-to-understand manner. In the example of the first embodiment described above, image quality enhancement processing is performed in real time on an image displayed in live view, and an image of a localized area obtained via image quality enhancement processing such as equal magnification display or the like is displayed to make the image quality enhancement processing effect easy to confirm. Regarding this, in the present embodiment, an example is described in which the image quality enhancement processing effect of the image (captured and stored image) reproduced after image capture is presented in an easy-to-understand manner.

The apparatus configurations according to the present embodiment are similar to those in the first embodiment and thus will not be described in detail. The processing flow is also similar to the processing flow described with reference to FIG. 3 in the first embodiment and thus will not be described. The differences with the first embodiment are found in the processing of the screen output processing unit 216 in FIG. 2 and the processing to display a screen of the results of the image quality enhancement processing of step S307 in FIG. 3.

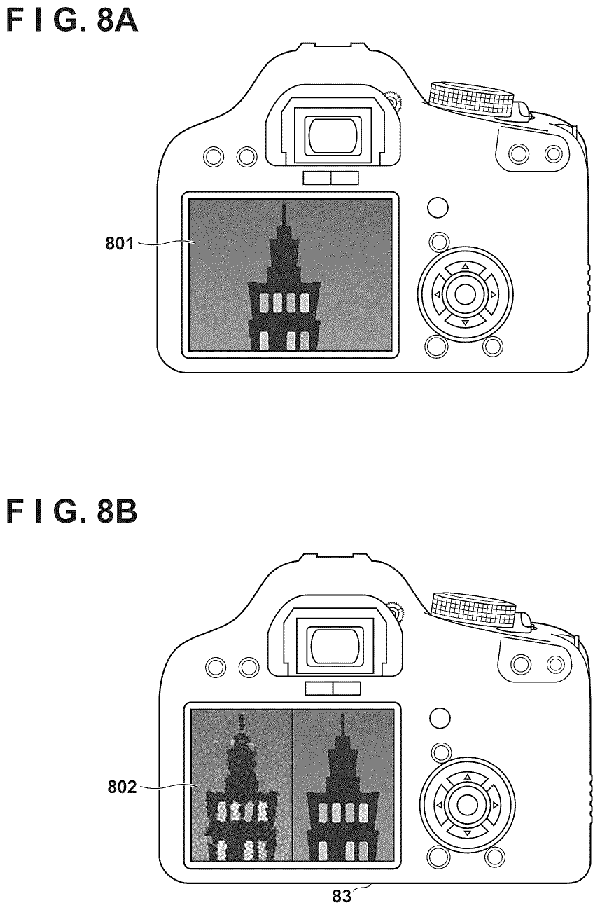

FIGS. 8A and 8B illustrate examples in which the processing content of the screen output processing unit 216 according to the present embodiment is displayed on the display unit 203. In the example of FIG. 8A, in steps S301 to S306 in FIG. 3, the image quality enhancement processing is performed on the second image selected by the user. In the present embodiment, it is assumed that the image quality enhancement processing is performed on an image reproduced after image capture. Thus, there is no need for a real-time aspect. Accordingly, the image quality enhancement processing can be performed on any localized area image selected by the user. At this time, the number of pixels of the localized area image does not need to be taken into account, and thus the processing of step S305 can be omitted.

Also, since there is no need to adjust the position of the camera 100 to match the motion of the subject, processing to display at equal magnification a third image 801 obtained via the image quality enhancement processing in step S306 in the entire display area of the display unit 203 is performed in step S307. Next, in the example of FIG. 8B, processing is performed to simultaneously display a second image 802 selected by the user in step S303 and a third image 803 obtained via the image quality enhancement processing in step S306 on the display unit 203 in step S307. In the present embodiment, to enable a comparison of the second image 802 and the third image 803, they are display horizontally side by side. However, no such limitation is intended, and they may be displayed vertically side by side.

Also, the changed contents of the setting parameter relating to the arithmetic and logic operation load of the NR processing described using FIG. 6B may be displayed side by side for comparison. In this case, the third image obtained via the image quality enhancement processing for the pre-change NR processing and the third image obtained via the image quality enhancement processing for the post-change NR processing may be simultaneously displayed on the display unit 203 in step S307.

### Third Embodiment

In another example of the present embodiment, image quality enhancement processing is performed in real time on an image displayed as a live view image, and an image of a localized area obtained via image quality enhancement processing such as equal magnification display or the like is displayed to make the image quality enhancement processing effect easy to confirm. In the first embodiment described above, the rear monitor of the camera is used as the display unit for outputting the result of the image quality enhancement processing. However, in the present embodiment, this is output and displayed in the viewfinder of the camera.

The apparatus configurations according to the present embodiment are similar to those in the first embodiment and thus will not be described in detail. The processing flow is also similar to the processing flow described with reference to FIG. 3 in the first embodiment and thus will not be described. The differences with the first embodiment are found in the display unit 203 in FIG. 2 and the output device that displays a screen of the results of the image quality enhancement processing of step S307 in FIG. 3.

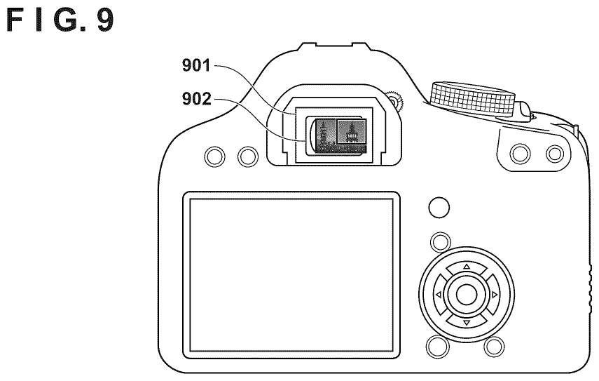

FIG. 9 is an example illustrating the display unit 203 according to the present embodiment. By displaying an output 902 in a similar manner as in step S307 in the first embodiment in an electronic view finder (EVF) 901 as a live view image for user confirmation, the image quality enhancement processing effect can be confirmed. The EVF functions as a display unit for confirming the subject to be captured. The present embodiment can also be applied to display example of the second embodiment, and by displaying the output 902 in the EVF 901, the image quality enhancement processing effect can be confirmed.

According to the present invention, the user can confirm the noise reduction effect at an early stage.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-215049, filed Dec. 20, 2023, which is hereby incorporated by reference herein in its entirety.

What is claimed is:

1. An image processing apparatus, comprising:
a selecting unit configured to select a localized area from a first image displayed in live view on a display unit;
a processing unit configured to generate a second image indicating the localized area from the first image and perform image quality enhancement processing on the second image; and
a control unit configured to display a third image obtained via the image quality enhancement processing by the processing unit on the display unit.

2. The image processing apparatus according to claim 1, wherein
the control unit displays the third image together with the first image on the display unit.

3. The image processing apparatus according to claim 1, further comprising:
an obtaining unit configured to obtain information of an ISO sensitivity; and
a determining unit configured to determine to perform the image quality enhancement processing via the processing unit in a case where the ISO sensitivity is equal to or greater than a threshold, wherein
the selecting unit selects the localized area in a case where the determining unit determines to perform the image quality enhancement processing.

4. The image processing apparatus according to claim 1, further comprising:
an obtaining unit configured to obtain information of an average brightness of the first image; and
a determining unit configured to determine to perform the image quality enhancement processing via the processing unit in a case where the average brightness is equal to or less than a threshold, wherein
the selecting unit selects the localized area in a case where the determining unit determines to perform the image quality enhancement processing.

5. The image processing apparatus according to claim 1, further comprising:
a dividing unit configured to divide the first image into a plurality of areas;
an obtaining unit configured to obtain information of an average brightness for each area of the plurality of areas; and
a determining unit configured to determine to perform the image quality enhancement processing via the processing unit in a case where a ratio of areas with the average brightness being equal to or less than a threshold is equal to or greater than a threshold, wherein
the selecting unit selects the localized area in a case where the determining unit determines to perform the image quality enhancement processing.

6. The image processing apparatus according to claim 1, further comprising:
a receiving unit configured to receive a user operation, wherein
the selecting unit selects a localized area displayed in equal magnification via the user operation on the first image displayed in live view on the display unit.

7. The image processing apparatus according to claim 1, further comprising:
a receiving unit configured to receive a user operation, wherein
the selecting unit selects the localized area on a basis of a focus position designated via the user operation on the first image displayed in live view on the display unit.

8. The image processing apparatus according to claim 1, wherein
the selecting unit selects the localized area on a basis of an object candidate area detected from the first image displayed in live view on the display unit.

9. The image processing apparatus according to claim 1, further comprising:
a presenting unit configured to present information indicating whether or not the image quality enhancement processing can be performed in real time on the second image indicating the localized area.

10. The image processing apparatus according to claim 1, further comprising:
an adjusting unit configured to adjust a number of pixels of the second image so that the image quality enhancement processing can be performed in real time on the second image indicating the localized area.

11. The image processing apparatus according to claim 1, wherein
the image quality enhancement processing is noise reduction processing.

12. The image processing apparatus according to claim 11, wherein
the processing unit can perform second noise reduction processing of a lighter processing load than the noise reduction processing, and
the processing unit can perform the second noise reduction processing on the second image indicating a localized area with a higher number of pixels than the second image and a wider area.

13. The image processing apparatus according to claim 1, wherein
the processing unit performs the image quality enhancement processing using a neural network trained to reduce noise.

14. The image processing apparatus according to claim 1, wherein
the control unit displays the third image at equal magnification superimposed on or combined with a predetermined area of the first image displayed in live view on the display unit.

15. The image processing apparatus according to claim 1, wherein
the control unit displays the second image together with the third image on the display unit.

16. The image processing apparatus according to claim 1, further comprising:
a selection receiving unit configured to receive selection of a predetermined mode from among a plurality of modes; and
a determining unit configured to determine to perform the image quality enhancement processing via the processing unit in a case where the predetermined mode is selected.

17. An image capturing apparatus, comprising:
an image processing apparatus comprising
a selecting unit configured to select a localized area from a first image displayed in live view on a display unit,
a processing unit configured to generate a second image indicating the localized area from the first image and perform image quality enhancement processing on the second image, and
a control unit configured to display a third image obtained via the image quality enhancement processing by the processing unit on the display unit; and
the display unit.

18. The image capturing apparatus according to claim 17, wherein
the display unit is a rear monitor of the image capturing apparatus or an electronic view finder (EVF) for confirming a subject to be captured.

19. A control method for an image processing apparatus, comprising:
selecting a localized area from a first image displayed in live view on a display unit;
processing to generate a second image indicating the localized area from the first image and perform image quality enhancement processing on the second image; and
displaying a third image obtained via the image quality enhancement processing by the processing on the display unit.

20. A non-transitory computer-readable storage medium storing a program for causing a computer to execute a control method for an image processing apparatus comprising:
selecting a localized area from a first image displayed in live view on a display unit;
processing to generate a second image indicating the localized area from the first image and perform image quality enhancement processing on the second image; and
displaying a third image obtained via the image quality enhancement processing by the processing on the display unit.
